(19) United States
(12) Patent Application Publication
(10) Pub. No.: US 2004/0236036 A1
(43) Pub. Date: Nov. 25, 2004

(54) Method for the production of graft polymers

(76) Inventors: Evgueni Avtomonov, Leverkusen (DE); Pierre Vanhoorne, Dusseldorf (DE); Burkhard Kohler, Leverkusen (DE)

Correspondence Address: BAYER MATERIAL SCIENCE LLC, 100 BAYER ROAD, PITTSBURGH, PA, 15205, US

(21) Appl. No.: 10/484,787

(22) PCT Filed: Jul. 16, 2002
(86) PCT No.: PCT/EP02/07873

(30) Foreign Application Priority Data
Jul. 26, 2001 (DE) 101 36 445.8

(51) Int. Cl. C08F 283/10

(52) U.S. Cl. 525/523; 525/529

(57) ABSTRACT

A process for the production of graft polymers is disclosed. Accordingly a mixture containing A) 50 to 98 parts by weight of vinyl monomers and B) 2 to 50 parts by weight of an epoxide or a mixture of epoxides is reacted in the presence of one or more multimetal cyanide catalysts. Optionally the resultant reaction mixture is further polymerized thermally or with the addition of additional free-radical formers, optionally together with the addition of further monomers. The inventive graft polymers are characterized by their excellent notched impact strength.

The invention relates to a process for the production of graft polymers by polymerising epoxides by means of multimetal cyanide catalysis in the presence of vinyl monomers and to the graft polymers obtainable by this process.

Graft polymers of styrene or of styrene, acrylonitrile and optionally methyl methacrylate on polybutadiene rubbers are known and are used industrially on a large scale. Due to the low glass transition temperature of the rubber phase, they have good low temperature toughness, but are sensitive of oxidative degradation, as the main chain of the rubber contains double bonds.

Graft polymers of styrene or styrene, acrylonitrile and optionally methyl methacrylate on rubbers having a saturated main chain, such as for example acrylate rubbers, EP(D)M or LLDPE, are also known. However, the glass transition temperatures of these rubbers are mainly above −60° C., such that the low temperature toughness of the corresponding graft polymers is not sufficient for all applications.

Impact-modified thermoplastics in which the rubber phase is not crosslinked have disadvantages with regard to their range of properties in comparison with those in which the rubber phase is crosslinked. For example, their morphology often changes during processing. It would thus be desirable to have graft polymers of vinyl monomers on crosslinkable rubbers which, on the one hand, have a low T_{g}, preferably of below −60° C., and, on the other, are more resistant to weathering than polydiene rubbers.

It is also desirable to carry out the production of the rubber (grafting backbone) in the presence of the graft monomers or in monomers as the solvent in order optionally to be able to perform graft polymerisation in the same vessel and thus to be able to dispense with isolating or transferring the rubber.

Graft polymers of vinyl monomers on epihalohydrin-containing polyalkylene ethers are already known (U.S. Pat. No. 3,632,840, GB-A 1 352 583, GB-A 1 358 184, U.S. Pat. No. 3,627,839). However, the rubber phase in these polymers is not crosslinked and the glass transition temperature (T_{g}) of this phase is above −50° C.

U.S. Pat. No. 4,500,687 describes impact-modified thermoplastics based on a resin matrix containing styrene and polyalkylene ether elastomers having a low T_{g} (below −60° C.) as grafting backbone. The process is based on in situ production of a very high molecular weight polyalkylene ether rubber in toluene and/or styrene as solvent with the assistance of specific catalysts containing aluminium and on further free-radical graft polymerisation of the vinyl monomer onto the polyalkylene oxide rubber produced. One disadvantage of the process described in U.S. Pat. No. 4,500,687 is the use of large quantities of catalyst, which may disrupt graft polymerisation and result in poorer product properties due to the quantities of catalyst remaining in the polymer. Moreover, conversion rates in the alkylene oxide polymerisation are distinctly below 100%, typically 30-60%. This entails an additional purification step to remove the toxic epoxides.

The object accordingly arose of providing a process for the production of weather resistant, impact resistant graft polymers, which process yields products having low residual catalyst content, wherein the rubber used is obtainable by a reaction which proceeds virtually quantitatively.

It has now surprisingly been found that ring-opening polymerisation of epoxides in the presence of vinyl monomers catalysed by multimetal cyanide compounds is already simultaneously accompanied by polymerisation of the vinyl monomers. The resultant reaction mixture optionally undergoes subsequent thermal or free-radical polymerisation. Graft polymers are obtained in which the disperse phase consists of polyalkylene oxides and the continuous phase consists of a resin matrix of vinyl monomers. These graft polymers are distinguished by excellent notched impact strength.

The present invention accordingly provides a process for the production of graft polymers, characterised in that

I) a mixture containing

A) 50 to 98 parts by weight of vinyl monomers and

B) 2 to 50 parts by weight of an epoxide or a mixture of epoxides

is reacted in the presence of one or more multimetal cyanide catalysts, and optionally

II) the resultant reaction mixture is further polymerised thermally or with the addition of additional free-radical formers, optionally together with the addition of further monomers.

The present invention also provides graft polymers obtainable by the process according to the invention.

Suitable vinyl monomers A) are those which, as a homopolymer or copolymer, yield a polymer having a glass transition temperature of at least 60° C., preferably of at least 90° C. Examples of suitable vinyl monomers are styrene, α-methylstyrene, indene, norbornene, acrylonitrile, methacrylonitrile, methyl methacrylate, maleic anhydride, maleimides, which may be substituted on the nitrogen atom by C₁ to C₁₈ alkyl or C₆ to C₁₀ aryl residues, (meth)acrylic acid esters having 1 to 18 C atoms in the alcohol component and glycidyl methacrylate. Of these, styrene, acrylonitrile or mixtures thereof are preferred, with styrene being most particularly preferred.

Mixtures of epoxides containing

(a) 80 to 100 parts by weight of one or more saturated epoxides,

(b) 0 to 20 parts by weight, preferably 2 to 15 parts by weight, particularly preferably 5 to 10 parts by weight of one or more unsaturated epoxides,

(c) 0 to 10 parts by weight, preferably 0 to 5 parts by weight of epoxides having hydrolytically crosslinkable groups and optionally

(d) 0 to 1 part by weight, preferably 0 to 0.5 parts by weight of one or more diepoxides, wherein the sum of components (a) to (d) is 100,

are in particular suitable as component B).

Epoxides suitable as component a) are, for example, ethylene oxide, propylene oxide, epoxides of olefins having 4 to 18 carbon atoms, such as for example 1-butene oxide, 2-butene oxide, 1-pentene oxide, 2-pentene oxide, isopropyl oxirane, hexene oxides, C₁ to C₁₈ alkyl glycidyl ethers, glycidyl esters having 1 to 18 carbon atoms in the ester residue together with mixtures of these compounds. Propylene oxide is preferred.

Suitable component (b) unsaturated epoxides are for example allyl glycidyl ethers, butadiene monoepoxide, isoprene monoepoxide, divinylbenzene monoepoxide, isopropenylphenyl glycidyl ether or glycidyl (meth)acrylate, wherein allyl glycidyl ether and glycidyl (meth)acrylate are preferred.

Suitable component (c) epoxides having hydrolytically crosslinkable groups are epoxides having groups, such as for example

(R¹O)ₙR²₃₋ₙSi— or XₙR²₃₋ₙSi—,

in which

R¹ and R² mean identical or different alkyl residues having 1 to 20 C atoms, preferably C₁-C₆ alkyl, particularly preferably methyl, arylalkyl residues having 7 to 26 C atoms, preferably aryl-C₁-C₄-alkyl, particularly preferably benzyl, or aryl residues having 6 to 20 C atoms, preferably C₆-C₁₀ aryl, particularly preferably phenyl,

n means an integer from 1 to 3 and

X means a halogen.

Examples are the epoxides of the formulae (C-I) to (C-IV)

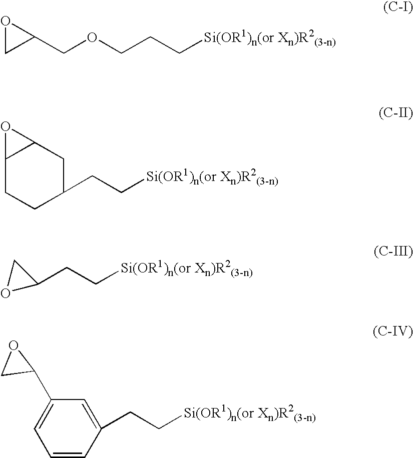

wherein the residues R¹, R², X and n have the above-stated meanings.

Of these, glycidyl(3-trimethoxysilylpropyl) ether (formula C-I, R^{I}=methyl, n=3) is preferred.

Suitable component (d) diepoxides are for example butadiene diepoxide, isoprene diepoxide, 2,4-hexadiene diepoxide, divinylbenzene diepoxide, vinylcyclohexene diepoxide, 1,4-butanediol diglycidyl ether or bisphenol A diglycidyl ether. Butadiene diepoxide is preferred.

Suitable multimetal catalysts contain double metal cyanide compounds of the general formula (V)

M¹ₓ[M²_{y}(CN)_{z}]_{w} (V),

in which

M¹ is selected from among Zn(II), Fe(II), Ni(II), Mn(II), Co(II), Sn(II), Pb(II), Fe(III), Mo(IV), Mo(VI), Al(III), V(V), V(IV), Sr(II), W(IV), W(VI), Cu(II), Cr(III) or mixtures thereof,

M² is selected from among Fe(II), Fe(III), Co(II), Co(III), Cr(II), Cr(III), Mn(II), Mn(III), Ir(III), Ni(II), Rh(III), Ru(II), V(IV), V(V) or mixtures thereof and

x, y, x and w are integers and are selected such that the double metal cyanide compound is electrically neutral.

Preferably, M¹ is selected from among Zn(II), Fe(II), Co(II) or Ni(II), M² is selected from among Co(III), Fe(III), Cr(III) or Ir(III) and x=3, y=1, z=6 and w=2.

Examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds may be found, for example, in U.S. Pat. No. 5,158,922. Zinc hexacyanocobaltate(III) is particularly preferred.

Suitable multimetal cyanide catalysts are known and are described in the above-stated prior art. Preferred catalysts are those as are described in EP-A 700 949, EP-A 761 708, WO 97/40086, WO 98/16310, DE-A 197 45 120, DE-A 197 57 574 and DE-A 198 102 269.

Further preferred multimetal cyanide catalysts are those which, in addition to a multimetal cyanide compound (for example zinc hexacyanocobaltate(III)) and tert.-butanol, also contain a polyether having a number average molecular weight of greater than 500 g/mol.

The multimetal cyanide catalyst or catalysts is/are generally used in quantities of 2×10⁶ to 0.025 wt. %, preferably of 2×10⁻⁵ to 2×10⁻⁴ wt. %, relative to the quantity of A)+B).

The multimetal catalyst may be preactivated prior to polymerisation, such that the induction period typical of a discontinuous production process of several minutes to a few hours does not occur and the heat of reaction is controlled by monomer apportionment and dissipated by the solvent, so increasing the safety of the process. Epoxides are suitable for preactivating the catalyst system, such as for example propylene oxide, 1-butene oxide, 1-pentene oxide, 1-hexene oxide, wherein the higher boiling epoxides, such as 1-hexene oxide, are preferred.

Polymerisation of the component A monomers in the presence of the resultant polyalkylene oxide during the polymerisation of component B may be performed according to the invention both without solvents and in solution and both continuously and discontinuously. Component B) may, to this end, be dissolved and initially introduced in pure vinyl monomer or pure monomer mixture A). Solvents which are inert under polymerisation conditions are optionally used for dilution, such as for example pentane, hexane, heptane, octane, benzene, chlorobenzene, toluene, ethylbenzene, xylenes, acetone, methyl ethyl ketone, diethyl ketone, ethyl acetate or methyl propionate or mixtures thereof. The vinyl monomers A) may here, in a manner known to the person skilled in the art, also be apportioned during the polymerisation of component B) which proceeds during the first reaction step.

The reaction is generally performed at temperatures of 20 to 200° C., preferably in the range from 40 to 180° C., particularly preferably in the range from 80 to 150° C. and may be performed at total pressures of 0.001 to 20 bar.

In the course of this reaction which proceeds in the first step, the component A) monomers are already copolymerised and grafted onto the resultant polyalkylene oxide.

Further graft polymerisation may proceed in a further step and be initiated by free-radical or thermal means. Grafting-active, free-radical initiators which dissociate at low temperatures are preferably used, in particular peroxides such as peroxoesters, peroxocarbonates, peroxodiesters, peroxodicarbonates, diacyl peroxides, perketals, dialkyl peroxides and/or azo compounds or mixtures thereof. Examples are tert.-butyl perpivalate, peroctoate, perbenzoate, pemeodecanoate, tert.-butyl-2-ethylhexyl percarbonate, dibenzoyl peroxide and dicumyl peroxide. The initiators are used in quantities of 0.01 to 2.5 wt. %, relative to component A). The organic free-radical formers may be added before and during polymerisation.

In some cases, it is possible to dispense with the addition of additional organic free-radical formers, as the latter are already present in the component B) alkylene oxide mixture, provided that the epoxides are not purified by special methods. A certain content of peroxide contaminants is already present in the component B) monomers, for example in propylene oxide, as a result of the production process and/or storage thereof (cf for example Ullmann's Encyclopedia of Industrial Chemistry, vol. A22, pp. 239-260, VCH, 1993).

The desired crosslinking of the rubber phase may simultaneously occur over the course of the graft polymerisation.

The reaction temperature during graft polymerisation is 25 to 180° C., preferably 50 to 170° C., particularly preferably 70 to 160° C. The reaction temperature may also be varied during graft polymerisation.

Polymerisation is generally continued until component B) is completely converted and the component A) monomers are 30 to 100% converted.

The polymer obtained in bulk without solvent or in solution may also be suspended in water and the reaction continued in suspension.

During polymerisation and before processing, it is possible to add conventional additives, such as chain-transfer agents, such as for example mercaptans, allyl compounds, dimeric α-methylstyrenes, terpinolene, dyes, antioxidants, lubricants, such as for example hydrocarbon oils, or stabilisers.

Once the desired monomer conversion has been achieved, solvents, residual monomers and further volatile constituents, such as oligomers and chain-transfer agents, may be removed using conventional methods, for example in heat-exchange evaporators, screw devolatilisers, strand devolatilisers, film or thin-layer evaporators.

The graft polymers produced using the processes according to the invention are suitable for the production of mouldings or semi-finished products by injection moulding or extrusion. They may also be processed with other polymers to form blends. Suitable blend components are for example vinyl (co)polymers, polycarbonates, polyesters, polyester carbonates and polyamides.

The following exemplary embodiments illustrate the invention in greater detail.

### EXAMPLES

Zinc chloride, potassium hexacyanocobaltate, tert.-butanol, propylene glycol (\overline{M}ₙ=1000), allyl glycidyl ether, propylene oxide, MDI (4,4′-methylenediphenyl diisocyanate) were purchased from Aldrich (Taufkirchen, DE) and 1-hexene oxide, cholic acid sodium salt and polyethylene glycol (\overline{M}ₙ=1000) from Fluka (Taufkirchen, DE) and used without further purification. The values for \overline{M}ₙ and \overline{M}_{w} were determined by gel permeation chromatography (GPC) in tetrahydrofuran (THF) at 25° C. with polystyrene calibration.

### Example 1

Activation of the Multimetal Cyanide Catalyst

20 mg of a multimetal cyanide catalyst, produced according to DE-A 199 20 937 (Example A), are suspended within 15 minutes using an ultrasound bath in 40 ml of toluene under argon. To this suspension are added 0.3 g of polyethylene glycol starter (\overline{M}ₙ approx. 1000 g/mol, Aldrich), 4 g of 1-hexene oxide (Aldrich) and stirring is performed for 3 hours at 110° C.

### Example 2 (Comparative Example)

Copolymerisation of Propylene Oxide with Allyl Glycidyl Ether by Means of Multimetal Cyanide Catalysis

1000 ml of toluene and 26.4 ml (13 mg of the multimetal cyanide catalyst) of catalyst solution from the Example described above are initially introduced into a 2 L reactor and heated to 110° C. 480 g of monomer mixture consisting of 448 g of propylene oxide (Aldrich) and 32 g of allyl glycidyl ether (Aldrich) are apportioned thereto within 3.5 hours with vigorous stirring (150 rpm). Once monomer addition is complete, the reaction mixture is refluxed while being stirred for a further 1.5 hours. A slightly turbid, viscous solution is obtained. After 5 hours, monomer conversion is 100%. The solvent is removed from the rubbery polymer under a vacuum at 50° C.

The following values are obtained:

\overline{M}ₙ=50 000 g/mol (GPC in THF, 30° C.), \overline{M}_{w}=200 000 g/mol

T_{g}=−70° C. (DSC, completely amorphous product)

### Example 3 (Comparative Example)

Behaviour of the Catalyst System from Example 1 in Destabilised Styrene

10 ml of destabilised styrene (passed over Al₂O₃) are heated for 6 hours to 110° C. while being stirred with 6.6 ml of catalyst solution from Example 1. No increase in viscosity is observable. The solids content is less than 2 wt. %.

### Example 4

Copolymerisation of Propylene Oxide with Allyl Glycidyl Ether by Means of Multimetal Cyanide Catalysis in Destabilised Styrene

6.6 ml of catalyst solution from Example 1 are initially introduced into 250 ml of destabilised styrene and heated to 110° C. while being stirred (200 rpm). A mixture of 56 g of propylene oxide (Aldrich, 99%) and 4 g of allyl glycidyl ether is apportioned thereto within 3 hours. Immediately addition is begun, the reaction mixture is observed to become turbid, with turbidity increasing over time. After 5 hours, the reaction is terminated by cooling and the solids content determined. The solids content (a white, plastic mass once volatile constituents have been removed) is 50%, which, at an epoxide conversion of 100%, corresponds to a composition of 40% polyalkylene oxide and 60% polystyrene.

The following values are obtained from the polymer:

\overline{M}ₙ=55 000 g/mol, \overline{M}_{w}=370 000 g/mol (GPC, 25° C., THF, polystyrene calibration)

T_{g}(1)=−70° C., T_{g}(2)=100° C. (DSC)

### Example 5

Copolymerisation of Propylene Oxide with Allyl Glycidyl Ether by Means of Multimetal Cyanide Catalysis in Stabilised Styrene.

The same method is used as described in Example 5, except that the styrene is not destabilised.

Exactly the same result is obtained as in Example 4.

### Example 6

Production of an Impact-Modified Polymer of Material from Example 4

The dispersion from Example 4 is diluted with 60 ml of styrene and 0.72 g of Irganox® 1076 (Ciba Specialities, Basle, Switzerland) and 0.3 g of dicumyl peroxide are mixed in. The reaction temperature is adjusted to 110° C. and the mixture is kept at this temperature without being stirred. After 1 hour, the temperature is increased to 150° C. and polymerisation is performed for 3 hours at this temperature. After cooling, the reactor contents are comminuted in a pelletiser and the pellets are dried for two days at 60° C. in a circulating air drying cabinet. 300 g of a white product are obtained.

Notched impact strength is measured to ISO 180 A1 on 80×40×10 test bars and is aₖ=10.2 kJ/m² (measured at room temperature).

### Example 7

Copolymerisation of Propylene Oxide with Allyl Glycidyl Ether by Means of Multimetal Cyanide Catalysis in a Styrene/Acrylonitrile Mixture

6.6 ml of catalyst solution from Example 1 are initially introduced into 300 g of a styrene/acrylonitrile mixture (75:25 parts by weight) and heated to 90° C. while being stirred (200 rpm). A mixture of 56 g of propylene oxide (Aldrich, 99%) and 4 g of allyl glycidyl ether are added thereto within 3 hours. Polymerisation of the alkylene oxides is complete after 5 h. The reaction mixture is then heated to 100° C. for 7 days without being stirred. Conversion is 94%. The reactor contents are comminuted in a pelletiser. 340 g of slightly turbid pellets are obtained. Slightly yellowish, translucent components are obtained from injection moulding.

1. A process for the production of graft polymers, wherein
I) a mixture containing
A) 50 to 98 parts by weight of vinyl monomers and
B) 2 to 50 parts by weight of an epoxide or a mixture of epoxides
is reacted in the presence of one or more multimetal cyanide catalysts and optionally
II) the resultant reaction mixture is further polymerised thermally or with the addition of additional free-radical formers, optionally together with the addition of further monomers.

2. A process according to claim 1, in which component A) contains styrene, α-methylstyrene, indene, norbornene, acrylonitrile, methacrylonitrile, methyl methacrylate, maleic anhydride, maleimides, which may be substituted on the nitrogen atom by C₁ to C₁₈ alkyl or C₆ to C₁₀ aryl residues, (meth)acrylic acid esters having 1 to 18 C atoms in the alcohol component, glycidyl methacrylate or mixtures thereof.

3. A process according to claim 1, in which component B) is a mixture containing
(a) 80 to 100 parts by weight of one or more saturated epoxides,
(b) 0 to 20 parts by weight of one or more unsaturated epoxides,
(c) 0 to 10 parts by weight of epoxides having hydrolytically crosslinkable groups and
(d) 0 to 1 part by weight of one or more diepoxides, wherein the sum of components (a) to (d) is 100.

4. A process according to claim 1, in which the multimetal catalyst is used in quantities of 2×10⁻⁶ to 0.025 wt. %, relative to A+B.

5. A process according to claim 1, in which the multimetal catalyst contains zinc hexacyanocobaltate(III), zinc hexacyanoiridate(III), zinc hexacyanoferrate(III) or cobalt(II) hexacyanocobaltate(III) or mixtures thereof.

6. A process according to claim 1, wherein the multimetal catalyst contains tert.-butanol.

7. Graft polymers obtainable by the process according to claim 1.

8. (Cancelled)

9. (Cancelled)

10. Mouldings obtainable from the graft polymers according to claim 7.
